(19) United States
(12) Patent Application Publication
(10) Pub. No.: US 2016/0215527 A1
(43) Pub. Date: Jul. 28, 2016

(54) UNIVERSAL HOLDER FOR A FOLDING BICYCLE LOCK

(71) Applicant: TRELOCK GmbH, Muenster (DE)

(72) Inventor: Winfried STEINKAMP, Duelmen (DE)

(21) Appl. No.: 14/813,299

(22) Filed: Jul. 30, 2015

(30) Foreign Application Priority Data
Aug. 8, 2014 (DE) 202014103690.3

(51) Int. Cl. E05B 67/38

(52) U.S. Cl. CPC E05B 67/38; E05B 2067/386

(57) ABSTRACT

A universal holder for a folding lock has a base bar fastenable to a bicycle strut and formed by a lower rail and an upper rail that can be displaced relative to each other and locked relative to each other by a mounting assembly. A retaining strap extends transversely across the base bar and is connectable to two sides of the upper rail. A support cup is provided on a lower end of the lower rail.

The invention relates to a universal holder for a folding lock, comprising a base bar having at least one means for fastening to a bicycle strut and a retaining strap.

Such holders are known from utility model DE 20 2007 011 170 where a holder for a bicycle accessory part is described that is attached to a base bar on a bicycle strut. The holder has two side flanges and a retaining strap that extends forward over the holder from the back side of the base bar that can be hooked into a pin head in order to secure the accessory from falling out.

The holder described in utility model DE 20 2007 011 170 is only suitable for accessories, in this case for folding locks, whose length does not exceed the length of the side flanges and of the retaining strap. But if the accessory has a length that is substantially less than the holder from utility model DE 20 2007 011 170, it becomes difficult to remove the accessory. Similarly, folding locks having a width that exceeds the space between the two inner sides of the side flanges cannot be transported by this holder. Due to the position of the retaining strap from the rear toward the front over the holder, as is also the case in other holders in the prior art, the holder also enables the removal of the folding lock only from above.

It is therefore an object of the invention to provide a flexible universal holder that is suitable for various folding locks of different dimensions.

According to the invention, this object is achieved in a universal holder of the type described above by making the base bar in the form of a lower rail and an upper rail that can be displaced relative to each other and can be locked to each other by a mounting assembly, by having the retaining strap extend transversely to the base bar and be connectable to sides of the upper rail, and by providing a support cup on a lower end of the lower rail.

According to the invention, it is possible, due to the length adjustment of the base bar by relative displacement of the two rails to transport folding locks of different length, or even of different width, different material and even different closing mechanisms; that is, it is possible to fix folding locks with different levels of security. Moreover, this embodiment of the universal holder increases the flexibility for the user, since the removal of the folding lock is no longer limited to the upward direction, but rather the folding lock can also be removed from the universal holder toward the front. This is advantageous especially in bicycles whose frame configuration provides only very little mounting space for locks. The folding lock can be removed from the holder with a slight forward tilting movement. This represents a substantial simplification of the removal of the folding lock. For example, removal of a folding lock that is located in the holder according to utility model DE 20 2007 011 170 must be performed upward past the entire length of the side flanges. The two rails that can be displaced relative to each other can be arranged next to each other, but due to the highly simplified ability to fix together the two rails, it is advantageous to arrange them one behind the other. The support cup and the retaining strap serve to hold the folding lock in the universal holder downward, toward the back, and toward the front. The fact that one securing means, the retaining strap, is provided on the upper rail and another securing means, the support cup, is on the lower rail makes it possible for the folding lock to be securely fixed in the holder even in the case of length adjustment. Within the scope of the invention, it is further preferred that the means for attachment to the bicycle strut comprises two spaced-apart holes on the lower rail, two slots on the upper rail running along the same longitudinal axis, and two threaded screws. This enables attachment of the universal holder to the bicycle strut even with different universal holder lengths. Moreover, it is also possible to adjust the universal holder without having to detach it from the bicycle strut. The fact that a holder is suitable for many different folding locks makes it possible for the manufacturer of folding locks to exploit synergistic effects during production, since it is no longer necessary for a different holder to be associated with each lock type, and a separate holder no longer needs to be produced for each lock type. Production, procurement and logistics are thus simplified substantially and rendered cost-effective, not least through the production of greater unit quantities of a single holder.

According to the invention, the support cup has a back wall that cooperates with the lower rail, two side walls and a front wall, that the height of the back wall is less than the length of the lower rail, and the height of the front wall is less than the height of the back wall. A support cup with a reduced height enables easy removal of the folding lock with a nonetheless high level of fixation and simultaneously reduced material consumption. In particular, it has proven advantageous if the back wall is transversely wider than the lower rail. As a result, folding locks of different widths can be received with reduced material consumption.

Within the scope of the invention, it is also preferred that the height of the front wall is adapted to the size of the hinge pins of the folding lock to be inserted into the support cup from its lower end. The optimal adaptation of the height of the front wall to the spacing of the hinge pins prevents the folding lock, and particularly the inner members of the folding lock, from tilting forward out of the universal holder with simultaneously little use of material.

Moreover, it has proven advantageous for the height of the side walls to decrease at an angle from the back wall to the front wall. The oblique side walls enable lateral protection from falling out with little material consumption. Alternatively, the side walls can also be rounded.

In particular, it is advantageous if an antislip unit is provided inside the support cup on its two side walls. The antislip unit can be a rubberized surface or in a surface coated with rubberized nubs, so that the nubs or the rubberized surface form a high-friction connection with the folding lock and the retaining strap. The antislip unit leads to additional fixation of the folding lock even under increased vibration and simultaneously serves, depending on the selection of the material of the universal holder, to protect the folding lock from being damaged by the universal holder, for example as a result of riding over uneven ground. Alternatively or in addition, the support cup can have a tapered receptacle on its interior whose surfaces are connected to one of the side walls via a locking member or a spring. This enables easy fitting and simplified insertion of different folding locks of different widths into the universal holder as well as additional fixation of the folding lock in the universal holder. Likewise, it is also possible for the surfaces of the conical receptacle to be mounted via locking members or via a spring on the front wall and on the back side of the interior of the support cup. This makes easy fitting and additional attachment of different folding locks of different depths possible. Moreover, a combination of the two approaches is of course conceivable in which the interior of the support cup forms a funnel-shaped seat whose surfaces are each connected to the two side surfaces, the back wall and the front wall via locking members or a spring.

Within the scope of the invention, the upper rail is T-shaped, the retaining strap has an arm connected to two pin heads, and the pin heads are at the free ends of the upper T-arms of the upper rail. The T-shaped design of the upper rail has the effect that folding locks that are wider than the width of the rail can also be held in the universal holder. At the same time, material consumption is reduced, thus resulting in a reduction of the weight of the universal holder. The retaining strap can be opened from one side or also from both sides, depending on whether the retaining strap has one arm or two arms. It is preferred that the retaining strap be on the upper ends of the T-arms of the upper rail; however, the retaining strap can also be in the middle, the position of the T-arms being adapted to the desired position of the retaining strap. In conjunction with the front wall of the support cup, the retaining strap enables the folding lock to be secured toward the front while simultaneously enabling removal of the folding lock not only upward but also toward the front.

Moreover, it is very especially preferred if the upper rail comprises a securing member. In one especially simple embodiment, this securing member can be embodied in the form of rubberized nubs that are located on the inner side of the upper T-arms of the upper rail. One alternative and very especially preferred approach is that the securing member is formed as a hold-down clip located on AN upper end of the upper rail. The securing member serves for additional fixation of the accessory in the case of increased vibration occurring when riding over uneven ground, for example. The hold-down clip generates a force that presses the folding lock downward toward the support cup. The hold-down clip is adjustable, for example by a locking seat.

It has proven advantageous for the mounting assembly to comprise at least one bore through at least the upper rail and one fastener. The mounting assembly serves to lock the lower rail to the upper rail at different lengths. In a preferred embodiment, the upper rail has two transversely spaced bores, whereas the lower rail has several bore pairs complementary thereto that are distributed over the length of the lower rail. The length of the base bar can be varied by displacement of the two rails relative to each other, and the position of the two rails, or the set length, can be fixed by two fasteners in the form of screws or rivets. An alternative approach is that the lower rail, instead of the bore pairs distributed over the length, has pairs of detent balls arranged at different positions over the length of the lower rail, which enables quick fixing and releasing of the two rails.

Moreover, it has proven advantageous if the retaining strap is formed as a grid. If the retaining strap is made of flexible material, folding locks of different widths can be optimally fixed.

Within the scope of the invention, it is advantageous for the upper rail and the lower rail to have different widths and for the upper rail to have two sections, a respective guide rib being embodied laterally on a back side of the upper first section, while the second lower section has e a respective retaining lip on its sides, and the back wall of the support cup has retaining grooves fitting the retaining lips laterally on the connecting surface between the lower rail and the back wall. In an especially preferred embodiment, the upper rail is wider than the lower rail and the two rails engage in each other by the guide ribs. As a result, displacement of the two rails relative to each other is greatly simplified and the two parts are prevented from falling apart. What is more, the retaining lips and the grooves enable the upper rail to form a positive fit with the lower rail and the support cup.

In summary, the universal holder according to the invention enables different folding locks of different widths, lengths and depths to be held with little material consumption. This results in a substantial reduction of costs for the manufacturer in the areas of logistics, production and procurement. The design of the support cup with a reduced height of the front surface and the retaining strap running around the base bar in the circumferential direction makes it possible to remove the folding lock not only upward, as in conventional holders, but also toward the front, thus improving user-friendliness. Through the interplay of retaining strap, support cup, securing member and antislip unit, all straight-line and rotational degrees of freedom are restricted. Consequently, the universal holder according to the invention enables a high degree of flexibility and user-friendliness both for the manufacturer and the end consumer.

In the following, the invention is explained in further detail on the basis of two illustrated embodiments shown in the drawings:

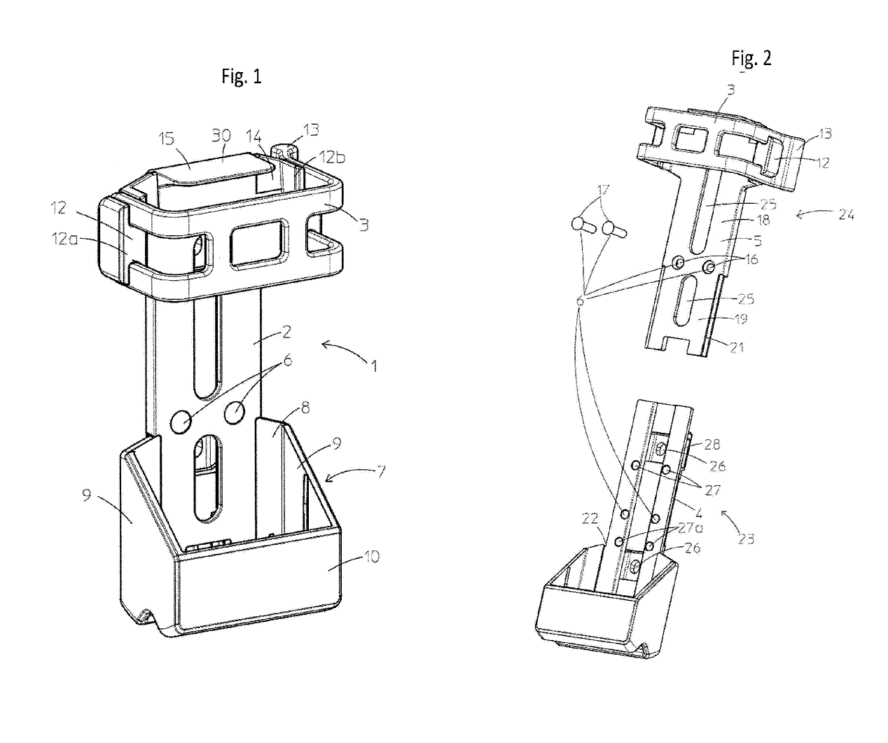

FIG. 1 is a front view of the first embodiment of the universal holder according to the invention in the home position,

FIG. 2 is a view of the and of lower parts of the first embodiment of the universal holder,

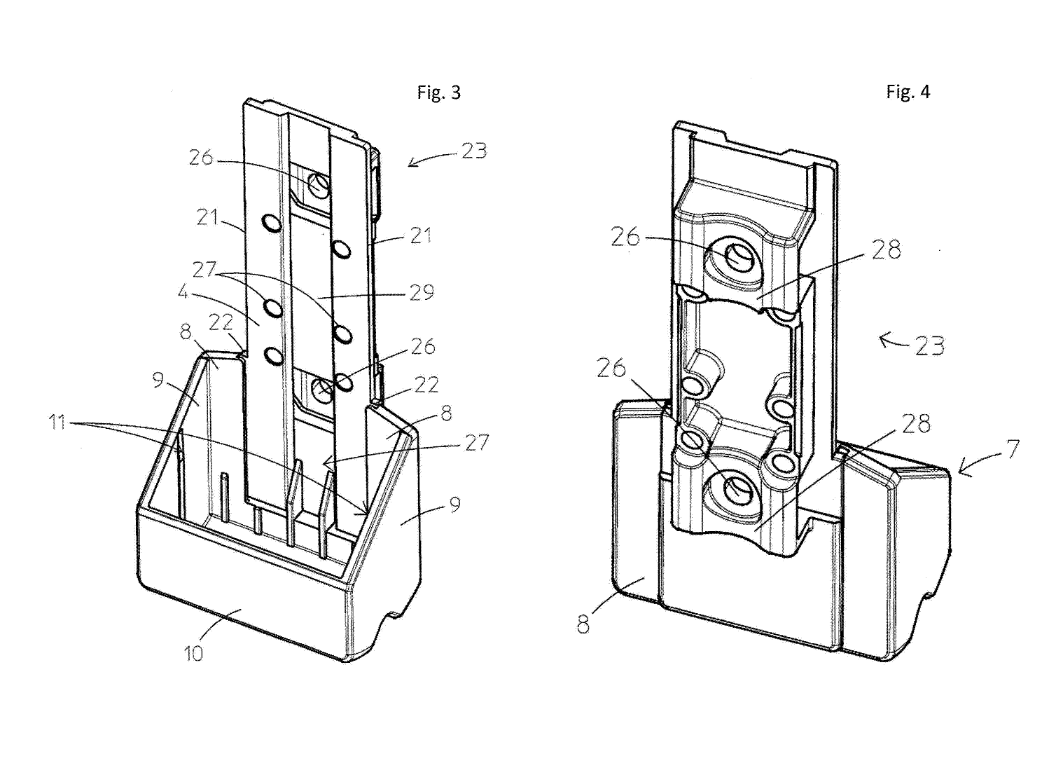

FIG. 3 is a front view of the lower part of a second embodiment of the universal holder,

FIG. 4 is a rear view of the lower part of the second embodiment of the universal holder,

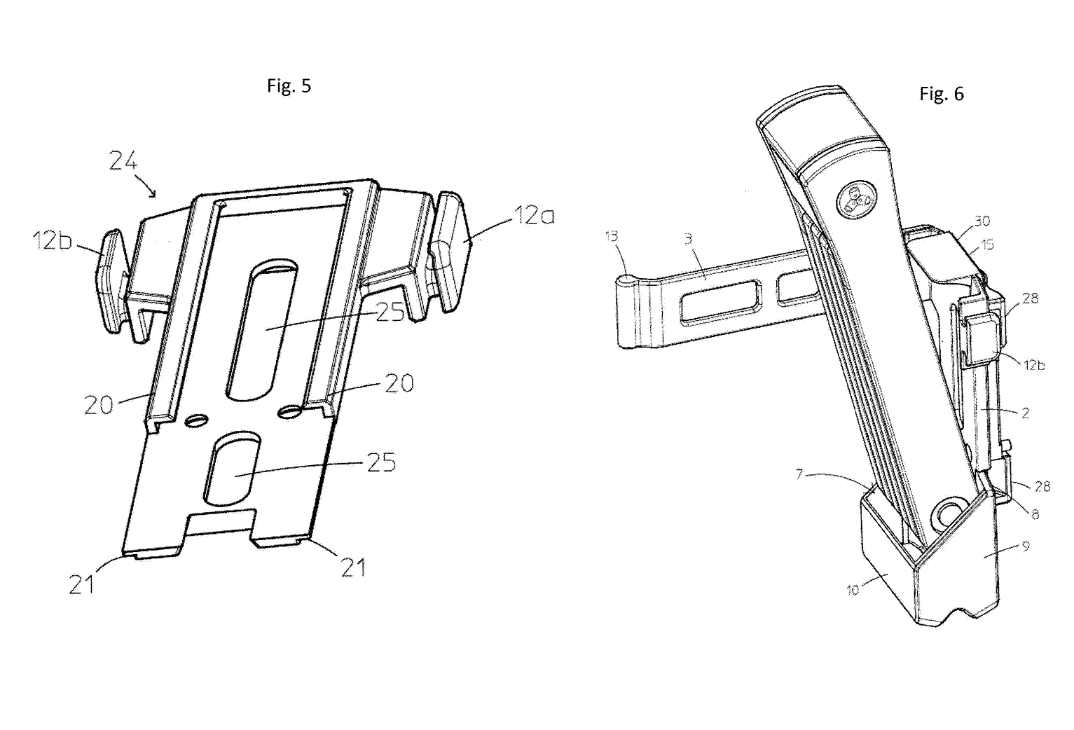

FIG. 5 is a rear view of the upper part of the second embodiment of the universal holder,

FIG. 6 is a side view of the first embodiment of the universal holder with an opened retaining strap.

FIG. 2 shows the construction of the first embodiment of the universal holder 1 according to the invention in the form of a lower part 23 and an upper part 24. The upper part 24 comprises a T-shaped upper rail 5, a retaining strap 3 formed as a grid and extending transversely between the T-arms 14 of the upper rail 5, two pin heads 12 projecting laterally from the T-arms 14, and one securing member 15 in the form of a hold-down clip 30 on the upper end of the upper rail 5 (FIG. 1). The right end of the retaining strap 3 is fixed by a right pin head 12a, and the left end of the retaining strap 3 has an tab 13 and can be hooked into a left pin head 12b in order to open and close the retaining strap 3. Moreover, the upper rail 5 has two slots 25 of different lengths running in the middle along a longitudinal axis and two transversely spaced bores 16 between the two slots 25.

The lower part 23 comprises a lower rail 4, a support cup 7 connected to the lower rail 4, two holes 26 in the middle spaced along the longitudinal axis, and three pairs of bores 27 that are at different spacings between the two holes 26 and whose diameters match the diameters of the bores 16 of the upper rail 5. The support cup 7 has a back wall 8 connected to the lower rail 4, two side walls 9 with upper edges running obliquely downward, and a front wall 10. The support cup 7 is wider than the lower rail 4. The height of the back wall 8 is selected such that, when fitted with the lower rail 4, it does not cover the first bore pair 27a. Moreover, the height of the front wall 10 conforms to the size of the hinge pins of the folding lock to be inserted into the support cup 7. Together with the lower rail 4 of the lower part 23, the upper rail 5 of the upper part 24 forms a base bar 2. Together with the fastener 17, which is formed by screws or rivets, the bores 16 on the upper part 24, the bore pairs 27 of the lower part 23 form a mounting assembly 6.

The upper rail 5 is wider than the lower rail 4 and has two sections: A respective guide rib 20 extends along each edge on a back face of the first upper section 18, and a respective retaining lip 21 extends along each edge of the second lower section 19. The guide ribs 20 are shown in the back view of FIG. 5 on a second illustrated embodiment of the universal holder 1 according to the invention, but they are also provided in the first embodiment. Respective retaining grooves 22 on the back wall 8 of the support cup 7 laterally on the connecting surface between the lower rail 4 and the back wall 8 are made to fit with the retaining lips 21 of the upper rail 5 (FIG. 3, FIG. 2 and FIG. 4).

The rear view of FIG. 4 shows the lower part 23 of the second embodiment of the universal holder 1 according to the invention. A respective rearward concave mounting face 28 is formed on the lower rail 4 extending along the longitudinal axis in line with the two holes 26 so that, when the universal holder 1 is attached to a bicycle strut, it fits complementarily to achieve solid mounting of the universal holder 1 on the bicycle strut. The rearwardly concave mounting surfaces are also provided in the first illustrated embodiment of the universal holder 1 according to the invention (FIG. 6).

Unlike the first illustrated embodiment, the lower part 23 of the second illustrated embodiment of the universal holder 1 according to the invention shown in FIG. 3 also has antislip formations 11 in the form of a rubber strip on the inner faces of the two side walls 9 of the support cup 7. The rubber strip also fixes the folding lock in the support cup 7 against lateral slippage and prevents the folding lock from being damaged during strong vibration, i.e. when driving over uneven ground, for example. Moreover, the lower rail 4 is not formed as a uniform surface. Relative to the middle part 29 of the lower rail 4, the retaining lips 21 are shifted forward. This saves material in the middle of the lower rail.

On assembly of the upper part 24 and of the lower part 23 of the universal holder 1 according to the invention, the lower rail 4 is inserted into the guide ribs on the back of the upper rail 5. The guide ribs 20 simplify sliding of the lower rail 4 and upper rail 5 of the base bar 2 relative to each other and prevent the two parts from coming apart. In addition, the two retaining lips 21 of the upper rail 5 engage in the complementary retaining grooves 22 on the back wall of the support cup 7 and also simplify displacement and prevent the upper part 24 and lower part 23 from falling apart. In the end position of the length-adjustable universal holder 1 shown in FIG. 1, the grooves 22 and retaining lips 21 fit positively together. In this end position, the two bores 16 of the upper part 24 align with on the first bore pair 27a on the lower part. The upper part 24 and the lower part 23 can then be fixed together by the two screw or rivet fasteners 17 that are guided through the two bores 16 and seat in bores 27, i.e. through the upper rail 5 and the lower rail 4. To adjust the universal holder 1 to a lock of another length, the upper part 24 of the universal holder 1 is pushed against the lower part 23 until the bores 16 of the upper part 24 align with another bore pair 27 of the lower part 23 at the desired length. The position of the upper part 24 and of the lower part 23 relative to each other can be locked again by the mounting assembly 6.

As shown in FIG. 2, it is possible with the universal holder 1 according to the invention to fit to folding locks of different lengths. The lower part 23 of the universal holder 1 has three bore pairs 27. By virtue of the slot 25 embodied on the upper part 24 of the universal holder 1, the holes 26, which serve to fix the universal holder 1 to the bicycle strut, are also accessible in the event of length adjustment, which means that the universal holder 1 can also be adjusted when it is already mounted on the bicycle strut. Besides the length adjustability, the universal holder 1 optimally fixes the folding lock that it receives. The design of the support cup 7 and the retaining strap running in the circumferential direction restrict the degrees of freedom of motion toward the front, to the side, toward the back and rotationally. The hold-down clip 30 also fixes the folding lock by pressing the folding lock downward, thus also restricting the vertical movement.

By virtue of the low height of the front wall 10 of the support cup 7, when the retaining strap 3 is opened, the folding lock can be removed not only upward but also toward the front (FIG. 6). This is extremely advantageous, especially in bicycles whose frame configuration makes only leaves a short mounting space.

List of References

| | |
|---|---|
| 1 | universal holder |
| 2 | base bar |
| 3 | retaining strap |
| 4 | lower rail |
| 5 | upper rail |
| 6 | mounting assembly |
| 7 | support cup |
| 8 | back wall |
| 9 | side walls |
| 10 | front wall |
| 11 | antislip unit |
| 12 | pin heads |
| 12a | right pin head |
| 12b | left pin head |
| 13 | arm |
| 14 | T-arms |
| 15 | securing member |
| 16 | bore |
| 17 | fastener |
| 18 | first upper section |
| 19 | second lower section |
| 20 | guide rib |
| 21 | retaining lip |
| 22 | detent recess |
| 23 | lower part |
| 24 | upper part |
| 25 | slots |
| 26 | holes |
| 27 | bore pairs |
| 27a | first bore pair |
| 28 | mounting surface |
| 29 | middle part |
| 30 | hold-down clip |

1. A universal holder for a folding lock, the holder comprising:
a base bar having at least one means for fastening to a bicycle strut and formed by a lower rail and an upper rail that can be displaced relative to each other and locked relative to each other by a mounting assembly;
a retaining strap extends transversely across the base bar and connectable to two sides of the upper rail; and
a support cup on a lower end of the lower rail.

2. The universal holder defined in claim 1, wherein the support cup has a back wall cooperating with the lower rail, two side walls and one front wall, a height of the back wall is less than a length of the lower rail, and a height of the front wall is less than the height of the back wall.

3. The universal holder defined in claim 2, wherein the height of the front wall is adapted to the size of hinge pins of a folding lock whose lower end is to be inserted into the support cup.

4. The universal holder defined in claim 2, wherein the height of the side walls decreases from the back wall to the front wall.

5. The universal holder defined in claim 2, wherein an antislip unit is provided inside the support cup on each of the two side walls.

6. The universal holder defined in claim 1, wherein the upper rail is T-shaped with upper T-arms and the retaining strap is connected to two pin heads on free ends of the upper T-arms of the upper rail.

7. The universal holder defined in claim 1, wherein the upper rail has a securing member.

8. The universal holder defined in claim 1, wherein the mounting assembly has at least one bore through at least the upper rail and one fastener.

9. The universal holder defined in claim 1, wherein the retaining strap is formed as a grid.

10. The universal holder defined in claim 1, wherein
the upper rail err and the lower rail are of different widths,
the upper rail has upper and lower sections and a respective guide rib on each edge on a back side of the upper section,
the lower section has edges provided with respective retaining lips, and
the back wall of the support cup has retaining grooves fitting with the retaining lips and on edges of a connecting surface between the lower rail and the back wall.
